(19) United States
(12) Patent Application Publication
(10) Pub. No.: US 2004/0219947 A1
(43) Pub. Date: Nov. 4, 2004

(54) Wireless transmission device for a computer peripheral

(76) Inventor: Chi Wang Tseng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/859,106

(22) Filed: Jun. 3, 2004

Related U.S. Application Data
(63) Continuation-in-part of application No. 09/741,188, filed on Dec. 21, 2000, now abandoned.

(51) Int. Cl. G02B 6/42

(52) U.S. Cl. 455/550.1

(57) ABSTRACT

A wireless transmission device for a computer peripheral includes a receiving module and an emitting module. The emitting module includes a control unit, at least one light-emitting component formed on the control unit, and an optical module. Whereby a signal light emitted by the light-emitting component is diffused by the optical module and then is non-directionally radiated into the air thereby realizing a multidirectional and multi-wideangle signal transmission for being readily received by the receiving module.

### BACKGROUND OF THE INVENTION

1. Field of the Invention

The present invention relates to a wireless transmission device, and particularly to a wireless transmission device for a computer peripheral.

2. Prior Art

A computer is typically connected to a peripheral, such as a mouse or a keyboard, via a wire cable, i.e., a hard-wired communication link. Depending upon the number of users, distance between terminals, number of peripherals, frequency of system reconfiguration, portability of the remote stations, etc., the hard-wired cable system may not be practical for a given application. Hence, various wireless communication technologies have been employed.

A conventional technology discloses that a signal light emitted from a photo emissive device and then converted to a substantially collimated light by an optical lens is outputted to a ceiling, then is diffused by a diffused reflection and finally is collected by a photoreceptor thereby realizing transmission and reception of the signal light. However, since the collimated light is output to the ceiling in one direction, the photoreceptor receives the signal light in one corresponding direction and so cannot realize multidirectional or omni directional reception of the signal light. Another technology discloses that a light-emitting module has a plurality of light emitting diodes (LEDs) that are non-directional as a whole for carrying out transmission of a signal light thereby realizing multidirectional reception of the signal light. However, since the plurality of LEDs is disposed at the emitting module toward different directions, the emitting module is bulky and complicated to make.

### SUMMARY OF THE INVENTION

Accordingly, an object of the present invention is to provide a wireless transmission device for a computer peripheral which realizes a multidirectional and multi-wideangle signal transmission through an optical module thereof.

Another object of the present invention is to provide a wireless transmission device for a computer peripheral that is simple and easy to make.

To achieve the above-mentioned objects and more, a wireless transmission device for a computer peripheral in accordance with the present invention includes a receiving module and an emitting module. The emitting module includes a control unit, at least one light-emitting component formed on the control unit, and an optical module. Whereby a signal light emitted by the light emitting component is diffused by the optical module and then is non-directionally radiated in the air thereby realizing a multidirectional and multi-wideangle signal transmission that is readily received by the receiving module.

Other objects, advantages and novel features of the present invention will be drawn from the following detailed embodiments of the present invention with attached drawings, in which:

### BRIEF DESCRIPTION OF THE DRAWINGS

FIG. 1 is a diagram for showing a transmission path of a wireless transmission device for a computer peripheral of the present invention;

FIG. 2 is a diagram for showing another transmission path of the wireless transmission device for a computer peripheral;

FIG. 3 is a diagram for showing a wireless transmission device for a computer peripheral in accordance with another embodiment of the present invention;

FIG. 4 is a diagram for showing a wireless transmission device for a computer peripheral in accordance with another embodiment of the present invention;

FIG. 5 is a diagram for showing a wireless transmission device for a computer peripheral of the present invention being applied to a wireless mouse and a computer.

### DESCRIPTION OF THE PREFERRED EMBODIMENTS

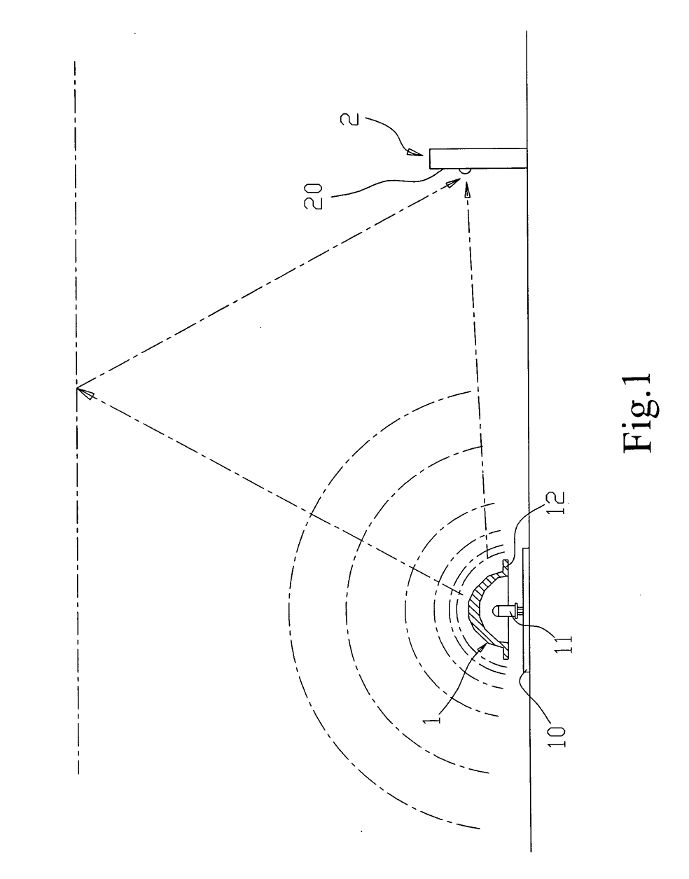

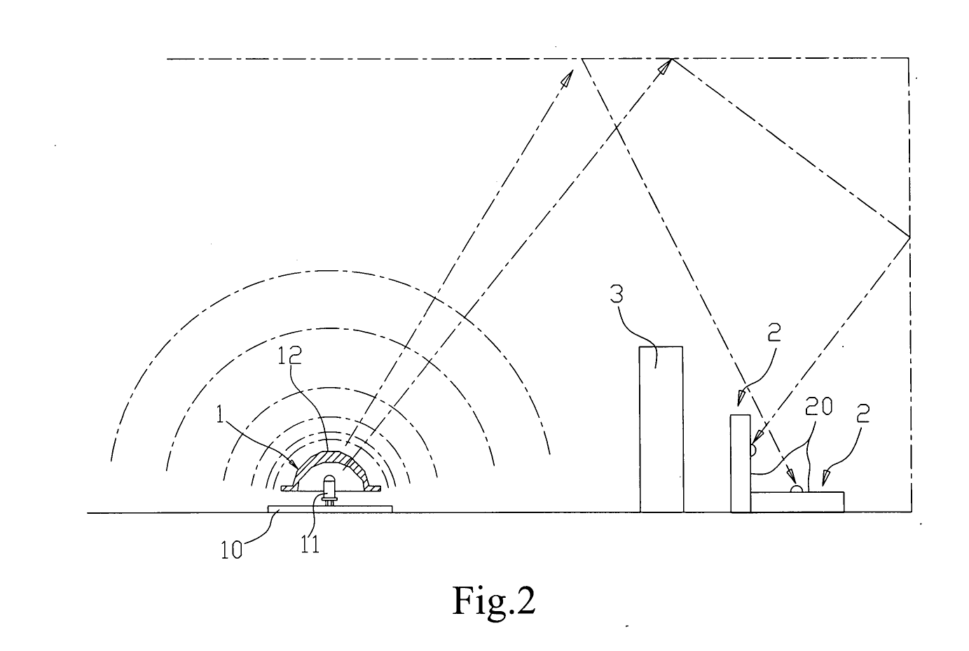

Referring to FIG. 1, a wireless transmission device for a computer peripheral of the present invention includes an emitting module 1 and a receiving module 2. The emitting module 1 includes a control unit 10. A light emitting component 11, for example, an infrared light emitting diode (LED) in this embodiment is formed on the control unit 10. An optical module 12 is formed above the light-emitting component 11. The optical module 12 is an optical diffusion component. The optical module 12 is generally hemispherical and covers the light-emitting component 11 therein for diffusing a signal light emitted by the light-emitting component 11 and then non-directionally radiating the signal light into the air. Therefore the signal light is non-directional as a whole thereby broadening the transmission area of the signal light and so realizing a multidirectional and multi-wideangle signal transmission. The radiated signal light is reflected by walls, ceilings, floors, etc., and then is output into the air thereby facilitating realization of the multidirectional and multi-wideangle signal transmission. As shown in FIG. 2, the signal light can bypass an obstacle 3. The signal light is also reflected by the obstacle 3 and then is output to the receiving module 2. Thus, the receiving module 2 can receive the signal light through the non-directional radiation and reflection, no matter in which direction a receiving surface 20 of the receiving module 2 faces.

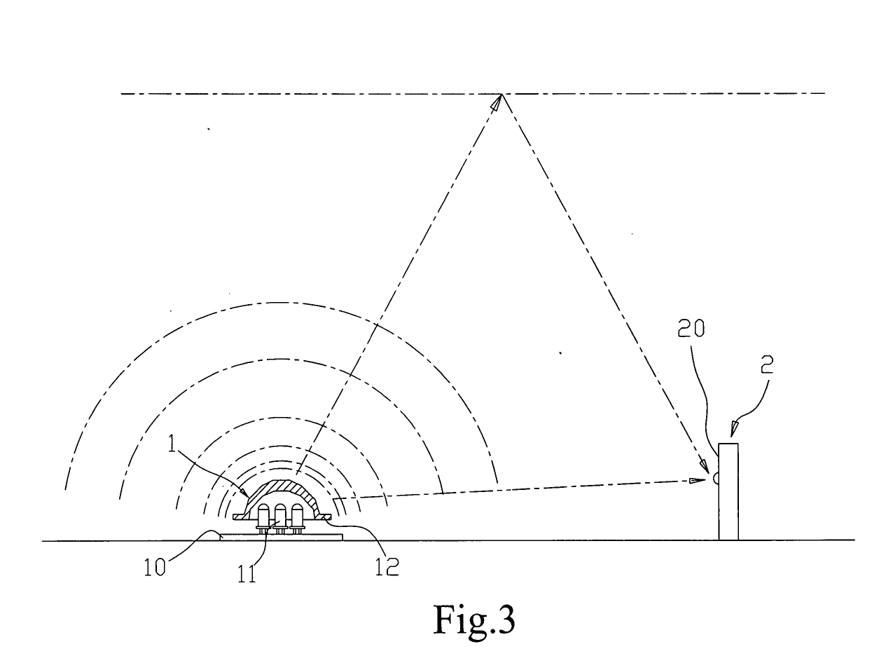

Referring to FIG. 3, the number of the light emitting components 11 of the control unit 10 is increased for meeting the demand of transmission power, depending upon the value of transmission power and length of transmission path. The light emitting components 11 may be arranged in a slanting manner for increasing light emitting efficiency.

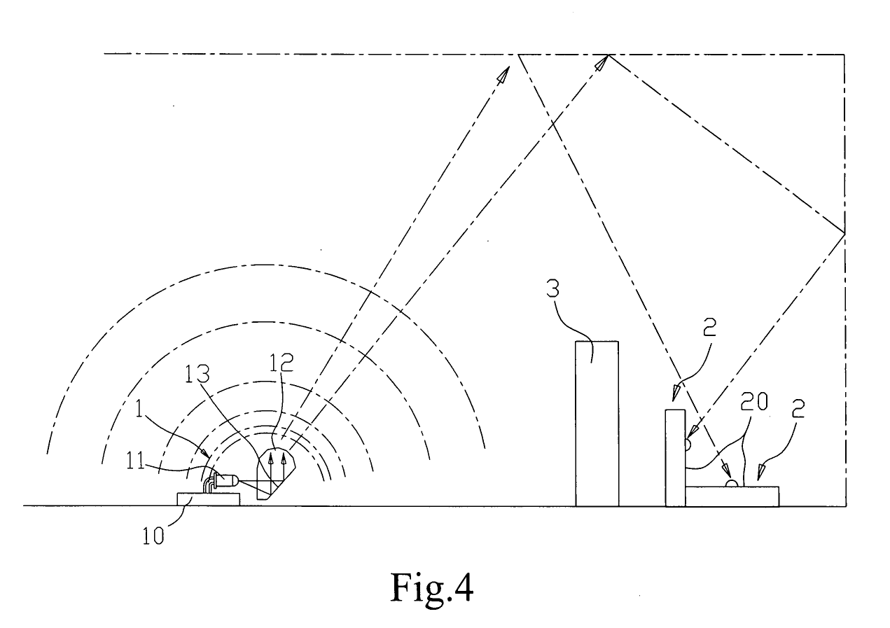

Referring to FIG. 4, the wireless transmission device of the present invention may include two or more receiving modules 2 which are connected in series or in parallel. Receiving surfaces 20 of the receiving modules 2 may face one direction, may be perpendicular to each other, or may be at an angle to each other. Therefore, the receiving modules 2 are ready to receive the signal light emitted from the emitting module 1. Furthermore, a reflecting surface 13 may be disposed at the emitting module 1 for reflecting the signal light emitted from the emitting module 1 to the optical module 12. The light-emitting component 11 is configured horizontally. The reflecting surface 13 is configured at an angle with respect to the light-emitting component 11. The optical module 12 covers the reflecting surface 13. Therefore, the position relationship of the light emitting component 11 and the optical module 12 is flexible. The reflecting surface 13 may be used for enhancing a signal light along a desired direction. The optical module 12 and the reflecting surface 13 may be integrally or detachably formed with each other.

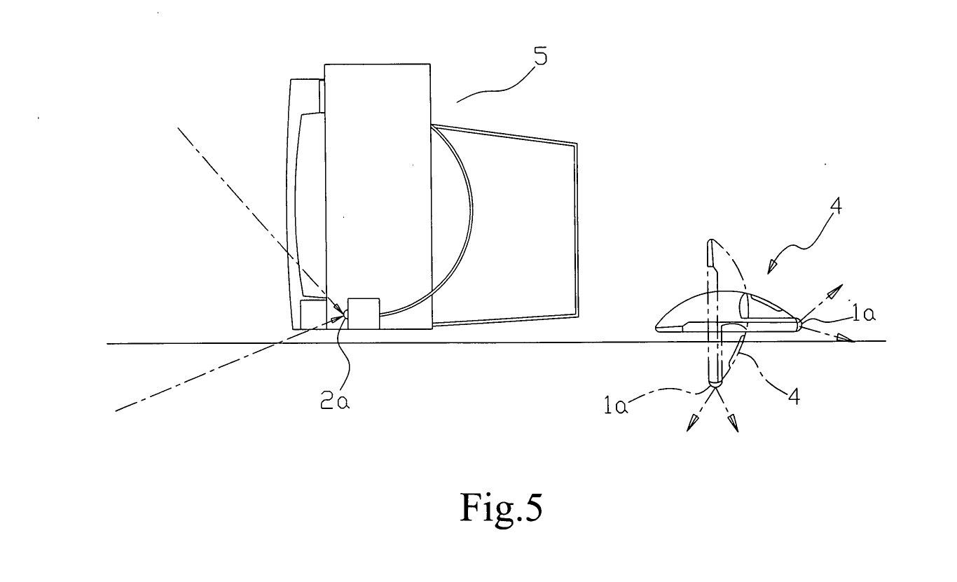

Referring to FIG. 5, the wireless transmission device for a computer peripheral of the present invention is applied to a wireless mouse 4 and a computer 5. A signal light emitted from the light-emitting component is diffused by the optical module and then is non-directionally radiated into the air. The radiated signal light is reflected once, twice or more by mediums of the environment thereby facilitating realization of non-directional transmission. Therefore, the emitting module la of the wireless mouse 4 and the receiving module 2a of the computer 2 are in non-directional communication. In other words, no matter what the relationship is between the emitting direction of the emitting module la and the receiving direction of the receiving module 2a is, the receiving module 2a can receive the signal light emitted from the emitting module 1a through non-directional transmission. Thus, the wireless transmission device of the present invention provides more flexibility in using the peripheral than conventional transmission devices.

Thus, the wireless transmission device for a computer peripheral of the present invention realizes a multidirectional and multi-wideangle signal transmission through an optical module thereof and is simple and easy to manufacture.

It is understood that the invention may be embodied in other forms without departing from the spirit thereof. Thus, the present examples and embodiments are to be considered in all respects as illustrative and not restrictive, and the invention is not to be limited to the details given herein.

1. A wireless transmission device for a computer peripheral comprising
a receiving module; and
an emitting module including a control unit, at least one light emitting component formed on the control unit, and an optical module, whereby a signal light emitted by the light emitting component is diffused by the optical module and then is non-directionally radiated into the air thereby realizing a multidirectional and multi-wideangle signal transmission for being readily received by the receiving module.

2. The wireless transmission device for a computer peripheral as claimed in claim 1, wherein the optical module is formed above the light-emitting component.

3. The wireless transmission device for a computer peripheral as claimed in claim 2, wherein the optical module covers the light emitting component therein.

4. The wireless transmission device for a computer peripheral as claimed in claim 1, wherein a reflecting surface is disposed at the emitting module for reflecting the signal light emitted from the emitting module to the optical module.

5. The wireless transmission device for a computer peripheral as claimed in claim 4, wherein the light-emitting component is configured horizontally.

6. The wireless transmission device for a computer peripheral as claimed in claim 5, wherein the reflecting surface is configured at an angle with respect to the light emitting component.

7. The wireless transmission device for a computer peripheral as claimed in claim 6, wherein the optical module covers the reflecting surface.

8. The wireless transmission device for a computer peripheral as claimed in claim 7, wherein the optical module and the reflecting surface are integrally formed with each other.

9. The wireless transmission device for a computer peripheral as claimed in claim 7, wherein the optical module and the reflecting surface are detachably formed with each other.

10. The wireless transmission device for a computer peripheral as claimed in claim 1, wherein the receiving module includes at least two receiving surfaces which are connected in series or in parallel.

11. The wireless transmission device for a computer peripheral as claimed in claim 1, wherein the light emitting component is an infrared light emitting diode.

12. The wireless transmission device for a computer peripheral as claimed in claim 1, wherein the optical module is hemispherical.

13. The wireless transmission device for a computer peripheral as claimed in claim 1, wherein the signal light diffused by the optical module and then non-directionally radiated into the air is reflected by mediums of the environment thereby facilitating realization of a multidirectional and multi-wideangle signal transmission.

14. The wireless transmission device for a computer peripheral as claimed in claim 1, wherein the optical module is an optical diffusion component.
